(19) United States
(12) Patent Application Publication
(10) Pub. No.: US 2024/0156060 A1
(43) Pub. Date: May 16, 2024

(54) PET COLLAR STRUCTURE

(71) Applicant: CHI-WEI LIN, Taipei City (TW)

(72) Inventor: CHI-WEI LIN, Taipei City (TW)

(21) Appl. No.: 17/985,171

(22) Filed: Nov. 11, 2022

(51) Int. Cl. A01K 27/00

(52) U.S. Cl. CPC A01K 27/005; A01K 27/001

(57) ABSTRACT

A pet collar structure includes a collar body and an elastic connecting member. The collar body includes beads, a first magnetic fastener and a second magnetic fastener. The first magnetic fastener and second magnetic fastener are detachably magnetically attracted to each other. The elastic connecting member includes a first sleeve portion and a second sleeve portion. The first sleeve portion sleeves the collar body and is positioned neighboring to the first magnetic fastener. The second sleeve portion sleeves the collar body and is positioned neighboring to the second magnetic fastener. With the coordination of the first magnetic fastener, the second magnetic fastener and the elastic connecting member, the collar body is worn on a neck of a pet. When the pet runs, scratches or shakes, with the elastic extension and elastic retraction of the elastic connecting member, the collar body is kept from falling off, hence achieving wearing stability.

### BACKGROUND OF THE INVENTION

### 1. Field of the Invention

The present disclosure relates to a pet collar structure, and in particular to a pet collar structure capable of achieving wearing stability.

### 2. Description of the Related Art

A common magnetically fastened pet collar often suffers from an application drawback of easily falling off while a pet runs, scratches or shakes.

Therefore, it is an object of the present disclosure to provide a pet collar structure that keeps a collar body from falling off while a pet runs, scratches or shakes, so as to achieve wearing stability and overcome the drawbacks of the prior art.

### BRIEF SUMMARY OF THE INVENTION

In view of the above drawbacks of the prior art, on the basis of extensive development with the practice of theories, the inventor has provided a pet collar structure, in the aim of keeping a collar body from falling off while a pet runs, scratches or shakes, hence achieving wearing stability.

To achieve the above and other objects, the present disclosure provides a pet collar structure including a collar body and an elastic connecting member. The collar body includes a plurality of beads, a first magnetic fastener and a second magnetic fastener. The first magnetic fastener and the second magnetic fastener are detachably magnetically attracted to each other. The first magnetic fastener is disposed on one end of the collar body, the second magnetic fastener is disposed on the other end of the collar body, and the beads are disposed between the first magnetic fastener and the second magnetic fastener. The elastic connecting member is disposed at the collar body, and includes a first sleeve portion and a second sleeve portion. The first sleeve portion sleeves the collar body and is positioned neighboring to the first magnetic fastener. The second sleeve portion sleeves the collar body and is positioned neighboring to the second magnetic fastener.

In the above pet collar structure, the collar body further includes a serial connecting portion. The serial connecting portion serially connects the beads, the first magnetic fastener and the second magnetic fastener.

In the above pet collar structure, the beads are made of a silicone material.

In the above pet collar structure, the elastic connecting member further includes a coupling portion. The first sleeve portion is disposed on one end of the coupling portion, and the second sleeve is disposed on the other end of the coupling portion.

In the above pet collar structure, the first sleeve portion, the second sleeve portion and the coupling portion are integrally made of a silicone material.

The above pet collar structure further includes an ornament, which is hung at the elastic connecting member.

Thus, the pet collar structure of the present disclosure, with the coordination of the first magnetic fastener, the second magnetic fastener and the elastic connecting member, enables the collar body to be worn on a neck of a pet. When the pet runs, scratches or shakes, with the elastic extension and elastic retraction of the elastic connecting member, the collar body is kept from falling off, hence achieving wearing stability.

### BRIEF DESCRIPTION OF THE DRAWINGS

FIG. 1 is a schematic diagram of an appearance of a preferred embodiment of the present disclosure.

FIG. 2 is an exploded schematic diagram of a preferred embodiment of the present disclosure.

FIG. 3 is a schematic diagram of a state of use of a preferred embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

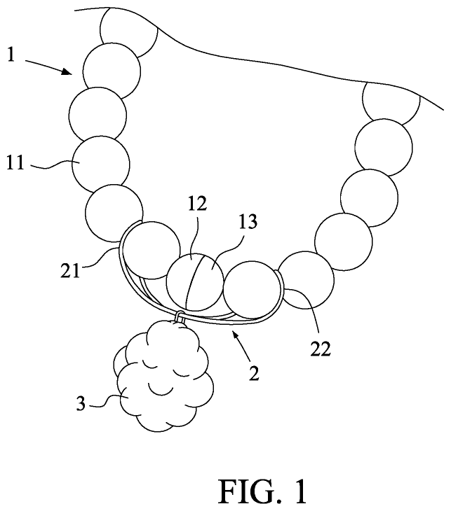

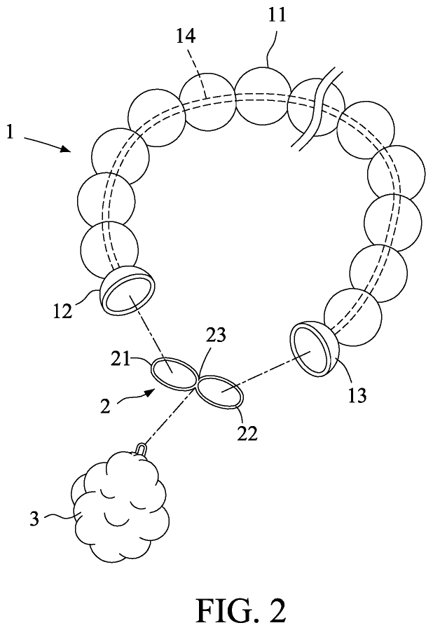

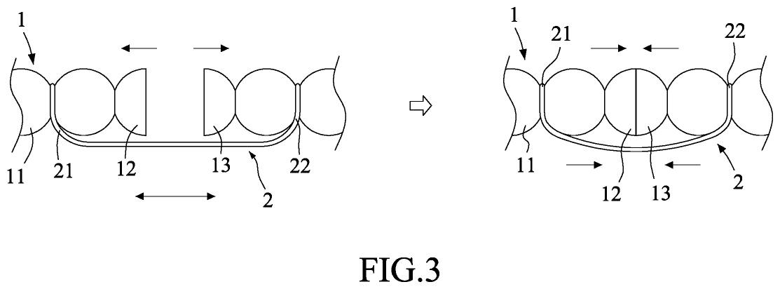

Referring to FIG. 1 to FIG. 3, as shown in the drawings, the present disclosure provides a pet collar structure including a collar body 1 and an elastic connecting member 2.

The collar body 1 includes a plurality of beads 11, a first magnetic fastener 12 and a second magnetic fastener 13. The first magnetic fastener 12 and the second magnetic fastener 13 are detachably magnetically attracted to each other. The first magnetic fastener 12 is disposed on one end of the collar body 1, and the second magnetic fastener 13 is disposed on the other end of the collar body 1. The beads 11 are disposed between the first magnetic fastener 12 and the second magnetic fastener 13.

The elastic connecting member 2 is disposed at the collar body 1, and includes a first sleeve portion 21 and a second sleeve portion 22. The first sleeve portion 21 sleeves the collar body 1 and is positioned neighboring to the first magnetic fastener 12. The second sleeve portion 22 sleeves the collar body 1 and is positioned neighboring to the second magnetic fastener 13.

To use the pet collar structure of the present disclosure, the collar body 1 can be placed around the neck of a pet, the first magnetic fastener 12 and the second magnetic fastener 13 are allowed to adhere to each other by attraction, and the first sleeve portion 21 of the elastic connecting member 2 is placed to sleeve a position neighboring to the first magnetic fastener 12, and the second sleeve portion 22 is placed to sleeve a position neighboring to the second magnetic fastener 13 such that the neck body 1 is worn around the neck of the pet with the coordination of the first magnetic fastener 12, the second magnetic fastener 13 and the elastic connecting member 2. When the first magnetic fastener 12 and the second magnetic fastener 13 are caused to separate from each other while the pet runs, scratches or shakes, with the properties of elastic extension and elastic retraction of the elastic connecting member 2 disposed, the elastic connecting member 2 receives a force and is deformed when the first magnetic fastener 12 and the second magnetic fastener 13 are separated from each other. Thus, with the property of elastic extension, the elastic connecting member 2 is still capable of pulling the first magnetic fastener 12 and the second magnetic fastener 13 by the first sleeve portion 21 and the second sleeve portion 22 while the elastic connecting member 2 receives a force and is deformed. At this point, although the first magnetic fastener 12 and the second magnetic fastener 13 are separated, the collar body 1 is yet kept around the neck of the pet. Then, with the property of elastic retraction of the elastic connecting member 2, the elastic connecting member 2 restores to an original state, and at the same time allowing the first magnetic fastener 12 and the second magnetic fastener 13 to be again fastened by mutual attraction. Thus, the collar body 1 is kept from falling off, hence achieving wearing stability.

Moreover, when the elastic connecting member 2 is arranged, the first sleeve portion 21 is first placed to sleeve and fit between one of the beads 11 and the first magnetic fastener 12, or the first sleeve portion 21 is placed to sleeve and fit between two beads 21 neighboring to the first magnetic fastener 12, and the second sleeve portion 22 is placed to sleeve and fit between one of the beads 11 and the second magnetic fastener 13, or the second sleeve portion 22 is placed to sleeve and fit between the second magnetic fastener 13 and two beads 11. Thus, the position for arranging the elastic connecting member 2 can be adjusted according to actual application conditions, allowing the elastic connecting member 2 to better practice the properties of elastic extension and elastic retraction.

In addition to the above embodiments, in one embodiment of the present disclosure, the collar body 1 further includes a serial connecting portion 14. The serial connecting portion 14 serially connects the beads 11, the first magnetic fastener 12 and the second magnetic fastener 13. Thus, the beads 11, the first magnetic fastener 12 and the second magnetic fastener 13 are provided with an effect of stable coupling using the serial connecting portion 14.

In addition to the above embodiments, in one embodiment of the present disclosure, the beads 11 are made of a silicone material. Thus, when the collar body 1 is worn round the neck of a pet, in addition to providing better safety, the material used can further prevent issues such allergies and itchiness of the pet.

In addition to the above embodiments, in one embodiment of the present disclosure, the elastic connecting member 2 further includes a coupling portion 23. The first sleeve portion 21 is disposed on one end of the coupling portion 23, and the second sleeve 22 is disposed on the other end of the coupling portion 23, such that the elastic connecting member 2 appears as a FIG. 8. The first connecting portion 21, the second connecting portion 22 and the coupling portion 23 are integrally made of a silicone material. Thus, the structural strength and stability of the elastic connecting member 2 can be reinforced, allowing the elastic connecting member 2 to better practice the properties of elastic extension and elastic retraction.

In addition to the above embodiments, one embodiment of the present disclosure further includes an ornament 3. The ornament 3 is hung at the elastic connecting member 2, and may be a charm or a pet name tag. Thus, identifiability and aesthetic values of the collar body 1 that is worn can be enhanced with the ornament 3.

The present disclosure is described by way of the preferred embodiments above. A person skilled in the art should understand that, these embodiments are merely for describing the present disclosure and are not to be construed as limitations to the scope of the present disclosure. It should be noted that all equivalent changes, replacements and substitutions made to the embodiments are to be encompassed within the scope of the present disclosure. Therefore, the scope of protection of the present disclosure should be accorded with the broadest interpretation of the appended claims.

What is claimed is:

1. A pet collar structure, comprising:
a collar body, comprising a plurality of beads, a first magnetic fastener and a second magnetic fastener, wherein the first magnetic fastener and the second magnetic fastener are detachably magnetically attracted to each other, the first magnetic fastener is disposed on one end of the collar body, the second magnetic fastener is disposed on one other end of the collar body, and the beads are disposed between the first magnetic fastener and the second magnetic fastener; and
an elastic connecting member, disposed at the collar body, the elastic connecting member comprising a first sleeve portion and a second sleeve portion, wherein the first sleeve portion sleeves the collar body and is positioned neighboring to the first magnetic fastener, and the second sleeve portion sleeves the collar body and is positioned neighboring to the second magnetic fastener.

2. The pet collar structure according to claim 1, the collar body further comprises a serial connecting portion, which serially connects the beads, the first magnetic fastener and the second magnetic fastener.

3. The pet collar structure according to claim 1, wherein the beads are made of a silicone material.

4. The pet collar structure according to claim 1, wherein the elastic connecting member further comprises a coupling portion, the first sleeve portion is disposed on one end of the coupling portion, and the second sleeve portion is disposed on one other end of the coupling portion.

5. The pet collar structure according to claim 4, wherein the first sleeve portion, the second sleeve portion and the coupling portion are integrally made of a silicone material.

6. The pet collar structure according to claim 1, further comprising an ornament, which is hung at the elastic connecting member.
